(19) United States
(12) Patent Application Publication
(10) Pub. No.: US 2017/0208830 A1
(43) Pub. Date: Jul. 27, 2017

(54) Processing Method for Poultry Oil

(71) Applicant: Kai-Neng Hwang, Tainan City (TW)

(72) Inventors: Kai-Neng Hwang, Tainan City (TW); Huei-Ping Tang, Tainan City (TW)

(21) Appl. No.: 15/359,018

(22) Filed: Nov. 22, 2016

(30) Foreign Application Priority Data
Jan. 27, 2016 (TW) 105102528
May 30, 2016 (TW) 105116870

(51) Int. Cl. A23D 9/04; A23D 9/007

(52) U.S. Cl. CPC A23D 9/04; A23D 9/007

(57) ABSTRACT

The invention discloses a processing method for poultry oil. The method comprises: placing a crude poultry oil at a predetermined temperature for forming a mixture containing liquid-type oil and solid-type oil; and harvesting the liquid-type oil from the mixture at the predetermined temperature. The predetermined temperature is set between 13° C. and 17° C., and the tolerance for the temperature measurement is ±2° C. Accordingly, compared to the crude poultry oil, the processed poultry oil has a good commercial appearance without solid precipitation at room temperature.

### CROSS REFERENCE TO RELATED APPLICATIONS

This application claims the priority of Application No. 105102528 filed in TAIWAN on Jan. 27, 2016 and Application No. 105116870 filed in TAIWAN on May 30, 2016 under 35 U.S.C. §119, the entire contents of all of which are hereby incorporated by references.

### BACKGROUND OF THE INVENTION

1. Field of the Invention

This invention relates to a processing method for poultry oil, to obtain a processed poultry oil with a preferable appearance that remained in liquid state without flocculent sedimentation at room temperature, and the processed chicken oil showed different fatty acids ratio in comparison with the original crude chicken oil.

2. Description of the Related Art

In general, the fat tissue of chicken can be fried or boiled, eliminate the dregs or water, to get the traditional chicken oil known as the crude chicken oil.

However, traditionally, the crude chicken oil seldom serves as a dietary oil. It appeared to has some solid-type oil (β-form) precipitate (flocculent sedimentation) at room temperature, and the precipitate can usually lead to an unfavorable impression in commerce. Moreover, the crude chicken oil appeared to have the saturated fatty acid (SFA):monosaturated fatty acid (MUFA):poly unsaturated fatty acid (PUPA), about 1:1.5:0.6 (Wei et al, Food Science 2012; 33(16): 188-193, Rondelli et al., Brazilian Journal of Poultry Science. 2004; 6 (3): 171-175). The fatty acids of the crude chicken oil showed little benefits to public health. Therefore, although chicken is the most consumed meat in the world, crude chicken oil is usually used as a feed for livestock instead of a source of dietary oil, and the situation of other kinds of crude poultry oil is quite similar.

In light of this, it is necessary to improve the appearance, to provide a processing method for crude poultry oil such as crude chicken oil, to obtain a processed poultry oil with few or mostly none flocculent sedimentation at room temperature. Furthermore, it will be another plus to show the processed chicken oil with improved fatty acids ratio, and to benefit more to the public health.

### SUMMARY OF THE INVENTION

The present invention is to provide a method to treat the crude poultry oil to get a processed poultry oil with better appearance, liquid and none flocculent sedimentation at room temperature.

The invention discloses a processing method for poultry oil, comprising putting a crude poultry oil at the predetermined low constant temperature to forming a liquid and solid mixed oil comprising liquid-type oil and solid-type oil, followed by harvesting the liquid-type oil. The predetermined low constant temperature is set between 13° C. and 17° C., with the tolerance of ±2° C.

In a preferred form shown, the temperature is set at 13° C. or 17° C., with the tolerance of ±0.5° C.

In a preferred form shown, the crude poultry oil is stirred at the temperature to help the formation of liquid/solid suspended crude poultry oil. For example, the crude poultry oil was stirred at 5 rpm for 12 hours or longer to help the formation of the liquid and solid mixed oil.

In a referred form shown, the liquid-type oil in above cold treated crude poultry oil was harvested. For example, the treated crude poultry oil was loaded in a filter bag (pore size 0.05 mm), centrifuges at 80 rpm for 20 minutes at the predetermined low temperature to get the liquid-type oil. This liquid-type oil is also known as the processed poultry oil.

### BRIEF DESCRIPTION OF THE DRAWINGS

The invention will be more comprehensive with the illustration, and not limitative of the present invention.

FIG. 1 shows crude chicken oil (cloudy sediment) on the right hand side, and the processed chicken oil (clear or transparency) on the left hand side.

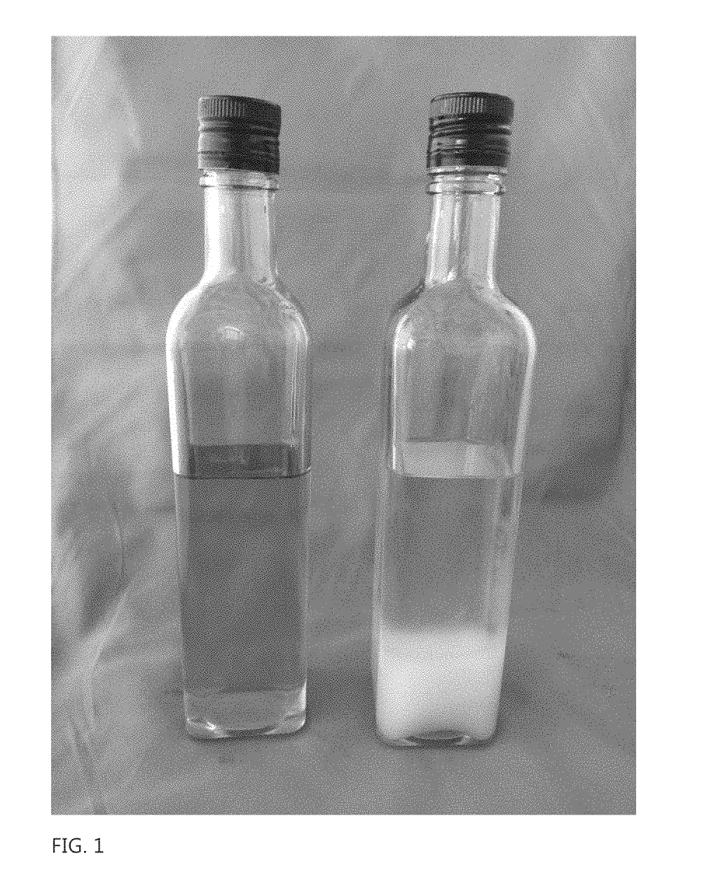

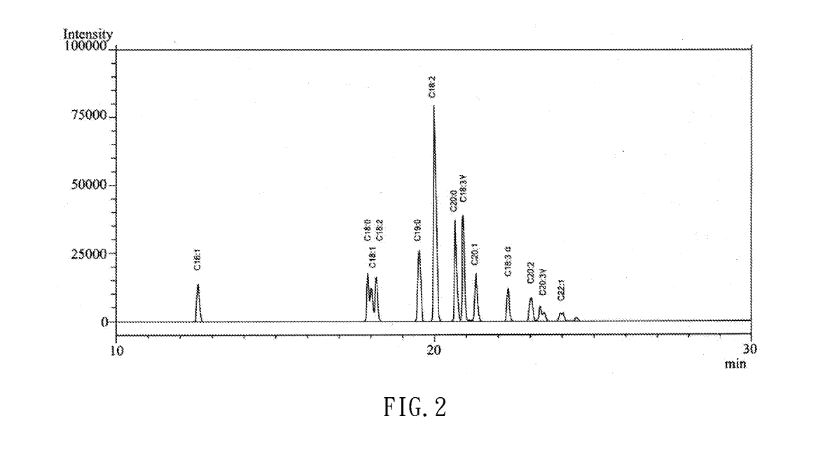

Analysis of the fatty acids of the chicken oil was done as the FDA Taiwan suggested method (NFS-0961800343), using an HP-88 column (Agilent, 100 m×0.25 mm I.D., 0.2 μm film thickness) with a FID detector, by Shimatzu GC Model-2010. A typical example of the chicken oil analyzed by gas chromatography (GC) was illustrated at FIG. 2.

### DETAILED DESCRIPTION OF THE INVENTION

To get the poultry oil, the fatty tissues of poultry were fried or boiled, get rid of the impurities of dregs or water, to get the crude poultry oil. This process can be appreciated by a person having ordinary skill in the art. The poultry mentioned in this invention is defined to consist of the chicken, duck, goose, and ostrich, and the chicken oil is taken as an example for the detailed illustration hereinafter.

In this invention, an example of 50 liters of crude chicken oil was put in a stainless pot (diameter×height=60×85 cm). Respectively, the pot was put in a cold room at the temperature 13° C. or 17° C., with the tolerance of ±2° C. Due to the solid-type oil formed on the pot wall would act as a good thermal insulator and interfere the phase transform of other oil, therefore, the oil was stirred with a paddle attached with silicon pads, at the speed of 5 rpm for 12 hours or longer. This stirring process would prevent the solid-type oil formed on the pot wall, and assure the evenly formation of the solid and liquid mixed oil.

The liquid-type chicken oil was then harvested from above mixed oil. For example, the mixed oil can be stood for 12 hours or longer at the predetermined low temperature to precipitate the solid-type oil, and to decant or to collect the upper liquid-type oil directly. In this invention, the low temperature treated oil is loaded in a filter bag to filter to get the processed chicken oil. An effectively example was to centrifuging the oil at 80 rpm for 20 minutes, using a nylon bag with pore size 0.05 mm, to harvest the liquid-type oil, known as the processed chicken oil. This cold treatment method and the liquid oil harvest process not only good for the chicken oil but also good for the duck, goose, and ostrich oil.

In order to understand the efficacy of the cold treatment method, and the fatty acids composition (SFA:MUFA:PUPA) of the processed chicken oils, following trials are done.

Respectively, the crude chicken oils are placed in a cold room with the temperature set at 25±0.5° C. (group A0), 21±0.5° C. (group A1), 17±0.5° C. (group A2), 13±0.5° C. (group A3) and 9±0.5° C. (group A4), and stirring constantly at 5 rpm for 12 hours or longer.

Respectively, the cold treated oil in group A0-A4 were collected and centrifuged at 80 rpm for 20 minutes, using a nylon bag with pore size 0.05 mm, and the liquid-type oils, the processed chicken oils were collected and analyzed by GC.

Results of the fatty acids analysis of the processed chicken oil was tabulated on Table 1.

TABLE 1

| | Temperature | Recovery rate | Fatty acids ratio |
|---|---|---|---|
| Group | (° C.) | (%) | (SFA:MUFA:PUPA) |
| A0 | 25 ± 0.5 | 100 | 1:1.5:0.6 |
| A1 | 21 ± 0.5 | 91 ± 5 | 1:1.6:0.7 |
| A2 | 17 ± 0.5 | 84 ± 7 | 1:1.8:0.8 |
| A3 | 13 ± 0.5 | 56 ± 6 | 1:1.6:0.9 |
| A4 | 9 ± 0.5 | 0 | ND |

The recovery rate (%) of the processed chicken oil is weights compared between the processed chicken oil to the crude chicken oil, as shown on TABLE 1. There was none liquid oil collected in the 9° C.-treated oil, and the fatty acids was none detected.

The fatty acids ratio of the crude chicken oil (1:1.5:0.6) was compared with the processed oils, and the fatty acids ratios in groups A2, A3 are significantly different from the crude chicken oil (Anova, p<0.05). These two oils also are similar to the fatty acid ratio (SEA MUFA:PUPA=1:1.5:1) suggested by Hayes et al. (Asia Pac J Clin Nutr. 2002; 11 Suppl 7: 5394-400). The processed chicken oil of Group A3 has the fatty acids ratio most similar to or insignificant difference with the suggested ratio of Hayes (Anova, p>0.05).

According to the fatty acids analysis in the above, it seems that a part of the crude chicken oil with SFA or MUFA, with palmitic acid and/or oleic acid, tends to transform to the β-form (solid-type oil) at low temperature (between 13° C. and 17° C.). However, most of the oil with PUFA remained in a-form (liquid-type oil). Such phenomena seemed lead the processed chicken oil to have different fatty acids ratio with higher PUFA then the crude chicken oil.

Furthermore, Simopoulos suggested that the good essential fatty acids ratio for n-6:n-3 is between 10:1 and 25:1 (Simopoulos et al. Poult Sci, 2000 July; 79(7): 961-70). The essential fatty acids ratio of n-6:n-3 of the processed chicken oil in group A3 is 12:1, and it meets the ratio suggested by Simopoulos. According to Simopoulos' report, the n-3 fatty acids show benefits in prevention and management of cardiovascular disease.

In conclusion, through the processing method for poultry oil, according to the present disclosure, the processed poultry oil showed none flocculent or none precipitate at room temperature. This transparency and none flocculent appearance is good for the commercial purposed. Furthermore, the processed chicken oil in the present disclosure also have a different fatty acids ratio from the crude chicken oil, and this fatty acids shift of the processed chicken oil has healthy benefits as Hayes and Simopoulos reported. Apparently, this invention opens a new gate for the utilization of the processed chicken oil as a healthy dietary oil.

Although the invention has been described in detail with references to its presently preferable embodiment, it will be understood by one of ordinary skill in the art that various modifications can be made without departing from the spirit and the scope of the invention, as set forth in the appended claims.

What is claimed is:

1. A processing method for poultry oil, comprising: placing a crude poultry oil at a predetermined temperature for forming a mixture containing liquid-type oil and solid-type oil; and harvesting the liquid-type oil from the mixture at the predetermined temperature, wherein the predetermined temperature is set between 13° C. and 17° C., and the tolerance for the temperature measurement is ±2° C.

2. The processing method for poultry oil as claimed in claim 1, wherein the predetermined temperature is set at 13° C., and the tolerance for the temperature measurement is ±0.5° C.

3. The processing method for poultry oil as claimed in claim 1, wherein the predetermined temperature is set at 17° C., and the tolerance for the temperature measurement is ±0.5° C.

4. The processing method for the poultry oil as claimed in claim 1, wherein the liquid-type oil is harvested by filtering out the solid-type oil of the mixture at the predetermined temperature.

5. The processing method for poultry oil as claimed in claim 4, wherein filtering out the solid-type oil comprises loading the mixture in a filter bag then centrifuging at 80 rpm for 20 minutes to collect the liquid-type oil.

6. The processing method for the poultry oil as claimed in claim 1, wherein the liquid-type oil is harvested by standing the mixture for a predetermined period of time to precipitate the solid-type oil, and to collect directly or by decantation the upper liquid-type oil.

7. The processing method for the poultry oil as claimed in claim 6, wherein the predetermined period of time is at least 12 hours.

8. The processing method for poultry oil as claimed in claim 1, the crude poultry oil is cold treated at the predetermined temperature with stirring to forming an evenly mixture of solid-type and liquid-type oil.

9. The processing method for poultry oil as claimed in claim 8, wherein the crude poultry oil is stirred at 5 rpm for at least 12 hours.

10. The processing method for poultry oil as claimed in claim 1, further comprising selecting the crude poultry oil from crude chicken, duck, goose, or ostrich oil before placing the crude poultry oil at the predetermined temperature.
